(19) United States
(12) Patent Application Publication
(10) Pub. No.: US 2007/0148978 A1
(43) Pub. Date: Jun. 28, 2007

(54) Slurry compositions, methods of polishing polysilicon layers using the slurry compositions and methods of manufacturing semiconductor devices using the slurry compositions

(76) Inventors: Eui-Jin Han, Suwon-si (KR); Nam-Soo Kim, Suwon-si (KR); Kyoung-Moon Kang, Gwangmyeong-si (KR); Dong-Jun Lee, Seoul (KR); Hyo-Sun Lee, Incheon (KR)

Correspondence Address: LEE & MORSE, P.C., 3141 FAIRVIEW PARK DRIVE, SUITE 500, FALLS CHURCH, VA, 22042, US

(21) Appl. No.: 11/642,582

(22) Filed: Dec. 21, 2006

(30) Foreign Application Priority Data
Dec. 22, 2005 (KR) 2005-127509

(51) Int. Cl. C09K 13/00; C03C 15/00; C23F 1/00; B44C 1/22

(52) U.S. Cl. 438/692; 252/79.1; 216/88

(57) ABSTRACT

A slurry composition, a method of polishing polysilicon layers using the slurry composition, and a method of manufacturing a semiconductor device using the same, wherein the slurry composition includes an abrasive in an amount of about 1 to about 20 percent by weight of the slurry composition, a non-ionic surfactant in an amount of about 0.005 to about 1 percent by weight of the slurry composition, and a solvent having a basic compound.

### BACKGROUND OF THE INVENTION

1. Field of the Invention

The present invention relates to slurry compositions, methods of polishing polysilicon layers using slurry compositions, and methods of manufacturing semiconductor devices using the same. More particularly, the present invention relates to slurry compositions capable of minimizing dishing of polysilicon layers during polishing thereof.

2. Description of Related Art

Semiconductor devices may include highly integrated and multi-layered configurations of elements and wiring that may require uniformly flat surfaces. Such surfaces may be formed by sequentially depositing a silicon oxide layer on a substrate, etching the silicon oxide layer to form a silicon oxide layer pattern, depositing a conductive layer on the silicon oxide layer pattern, and planarizing the conductive layer. A conventional planarization of the conductive layer may be performed via a chemical mechanical polishing (CMP) process, such that portions of the conductive layer may be removed to form a desired pattern.

The conventional CMP process may be performed by a CMP apparatus having a substrate attached between a polishing head and a polishing pad, and a slurry composition provided between the substrate and the polishing pad. The conventional slurry composition may include abrasives and water, and it may have an etching selectivity between substrate layers, e.g., between a polysilicon layer to be polished and an isolation layer functioning as a polishing stop. A layer of the substrate to be polished, e.g., a polysilicon layer, may be in contact with the polishing pad and be polished during simultaneous rotation of the polishing head and the polishing pad. Accordingly, upon contact between the substrate, the abrasives in the slurry composition and the polishing pad, the substrate may be polished by chemical reaction and mechanical friction. In general, the polishing efficiency of the CMP process may depend on the CMP apparatus and the slurry composition.

However, in a conventional CMP process, dishing, i.e., creation of surface defects due to excessive removal of material portions, may be caused at a polished surface, thereby decreasing the electrical operation of the semiconductor device.

For example, in a conventional manufacturing process of non-volatile semiconductor devices, a CMP process may be employed to form floating gates. A predetermined thickness of floating gates in a cell area and a peripheral circuit area of the substrate may impart proper electrical characteristics to the floating gates and, thereby, to the overall electrical operation of the non-volatile semiconductor device.

In particular, a width and a thickness of a floating gate in the non-volatile semiconductor device may determine an area of the floating gate and, thereby, a capacitance of a dielectric layer thereabove. Since high capacitance of the dielectric layer may provide a high coupling ratio and, thereby, enhance the electrical operation of the non-volatile semiconductor device, proper control of the floating gate area may be beneficial. Nonetheless, since the width of the floating gate is determined by a design rule of the non-volatile semiconductor device, control of the thickness of the floating gate and its uniformity may become important in providing high coupling ratio and capacitance of the dielectric layer. Dishing during formation of floating gates may produce non-uniform surfaces, thereby decreasing the electrical operation thereof.

Accordingly, there exists a need for a CMP process capable of minimizing substrate dishing during polishing thereof.

### SUMMARY OF THE INVENTION

The present invention is therefore directed to a slurry composition, a method of polishing using the slurry composition, and a method of manufacturing semiconductor devices using the slurry composition, which substantially overcome one or more of the problems due to the limitations and disadvantages of the related art.

It is therefore a feature of an embodiment of the present invention to provide a slurry composition capable of minimizing substrate dishing during polishing thereof.

It is another feature of an embodiment of the present invention to provide a polishing method of polysilicon layers using a slurry composition capable of minimizing substrate dishing during polishing thereof.

It is yet another feature of an embodiment of the present invention to provide a method of manufacturing a semiconductor device using a slurry composition capable of enhancing electrical operation thereof.

At least one of the above and other features of the present invention may be realized by providing a slurry composition including an abrasive in an amount of about 1 to about 20 percent by weight of the slurry composition, a non-ionic surfactant in an amount of about 0.005 to about 1 percent by weight of the slurry composition, and a solvent including a basic compound. The slurry composition may have a pH of about 9 to about 12.

The abrasive may include colloidal silica, cerium oxide, fumed silica, or a mixture thereof. Additionally, the abrasive may include colloidal silica having a particle size of about 30 nm to about 300 nm.

The non-ionic surfactant may include polyoxyethylene isooctylcyclohexyl ether represented by Formula (1): 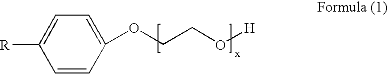
wherein R is an alkyl group and X is an integer in a range of 9 to 40.

Alternatively, the non-ionic surfactant may include polyoxyethylene sorbitan fatty acid ester represented by Formula (2): 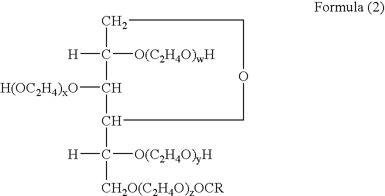
wherein R is an alkyl group, and x, y, z and w are positive integers with the proviso that 20≦x+y+z+w≦100.

The basic compound of the solvent may include tetramethyl ammonium hydroxide, tetraethyl ammonium hydroxide, potassium hydroxide (KOH), ammonium hydroxide (NH₄OH), tetrabutyl ammonium hydroxide, cyclohexyl amine, tetramethyl ammonium chloride, tetraethyl ammonium chloride, or a mixture thereof.

In another aspect of the present invention, there is provided a method of polishing a polysilicon layer, including depositing a polysilicon layer on a silicon oxide layer formed on a substrate; preparing a slurry composition having about 1 to about 20 percent by weight of abrasive, about 0.005 to about 1 percent by weight of a non-ionic surfactant, and a solvent having a basic compound; providing the slurry composition onto the polysilicon layer; and polishing the polysilicon layer to form a polysilicon layer pattern by a chemical mechanical polishing (CMP) process.

Preparing the slurry composition may include employing colloidal silica having a particle size of about 30 nm to about 300 nm. Additionally, preparing the slurry composition may include employing polyoxyethylene isooctylcyclohexyl ether as the non-ionic surfactant, the polyoxyethylene isooctylcyclohexyl ether represented by Formula (1): 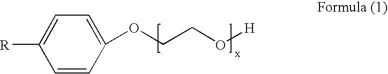
wherein R is an alkyl group and X is an integer in a range of 9 to 40. Alternatively, preparing the slurry composition may include employing polyoxyethylene sorbitan fatty acid ester as the non-ionic surfactant, the polyoxyethylene sorbitan fatty acid ester represented by Formula (2): 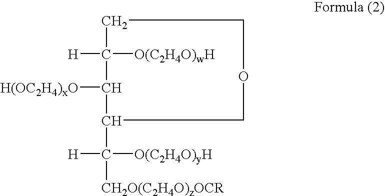
wherein R is an alkyl group, and x, y, z and w are positive integers with the proviso that 20≦x+y+z+w≦100.

Polishing the polysilicon layer may include removing the polysilicon layer until the silicon oxide layer is exposed. Further, polishing the polysilicon layer may include removing the polysilicon layer from a concaved surface of the silicon oxide layer.

In another aspect of the present invention, there is provided a method of manufacturing a semiconductor device, including providing a substrate having a cell area and a peripheral circuit area; forming a mask layer pattern on the substrate; etching the substrate through the mask layer pattern to form a plurality of trenches in the substrate; depositing an isolation layer on the substrate, such that the isolation layer is in contact with inside surfaces of sidewalls of the trenches; removing the mask layer to expose an upper surface of the substrate, such that the isolation layer is protruding above the upper surface of the substrate; depositing a tunnel oxide layer on the upper surface of the substrate; forming a polysilicon layer on the substrate, such that the polysilicon layer is in contact with the tunnel oxide layer and the isolation layer; polishing the polysilicon layer with a slurry composition to form a floating gate, wherein the slurry composition includes about 1 to about 20 percent by weight of abrasive, about 0.005 to about 1 percent by weight of a non-ionic surfactant, and a solvent with a basic compound; forming a dielectric layer on the floating gate; and forming a control gate on the dielectric layer.

Depositing the isolation layer on the substrate may include forming a first portion of the isolation layer having a first width in the cell area of the substrate, and forming a second portion of the isolation layer having a second width in the peripheral circuit area of the substrate, such that the second width is larger than the first width. Also, depositing the isolation layer on the substrate may include filling up the trenches. Depositing the isolation layer on the substrate may also include applying a layer of silicon oxide.

Polishing the polysilicon layer to form a floating gate may include forming a floating gate having a lower thickness as compared to a thickness of the mask layer. Polishing the polysilicon layer with the slurry composition may also include chemical mechanical polishing until the isolation layer is exposed.

### BRIEF DESCRIPTION OF THE DRAWINGS

The above and other features and advantages of the present invention will become more apparent to those of ordinary skill in the art by describing in detail example embodiments thereof with reference to the attached drawings, in which:

FIG. 1 illustrates a cross-sectional view of a chemical mechanical polishing apparatus utilizing slurry compositions in accordance with an example embodiment of the present invention;

FIG. 2 illustrates a flow chart of a method of polishing a polysilicon layer using a slurry composition in accordance with an example embodiment of the present invention;

FIGS. 3 to 10 illustrate cross-sectional views of sequential steps in a method of manufacturing a semiconductor device according to an example embodiment of the present invention; and

FIG. 11 illustrates a graph of polishing rates of polysilicon layers with respect to a Comparative Example and Examples 1 to 8.

### DETAILED DESCRIPTION OF THE INVENTION

Korean Patent Application No. 2005-127509 filed on Dec. 22, 2005, in the Korean Intellectual Property Office, and entitled: “Slurry Compositions, Methods of Polishing Polysilicon Layers Using the Slurry Compositions and Methods of Manufacturing Semiconductor Devices Using the Slurry Compositions,” is incorporated by reference herein in its entirety.

The present invention will now be described more fully hereinafter with reference to the accompanying drawings, in which example embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

It will further be understood that when an element is referred to as being “on” another element, layer or substrate, it can be directly on the other element, layer or substrate, or intervening elements or layers may also be present. Further, it will be understood that when an element or layer is referred to as being “under” another element or layer, it can be directly under, or one or more intervening elements or layers may also be present. In addition, it will also be understood that when an element or layer is referred to as being “between” two elements or layers, it can be the only element or layers between respective two elements or layers, or one or more intervening elements or layers may also be present. Likewise, it will be understood that when an element or layer is referred to as being “connected to” or “coupled to” another element or layer, it can be directly connected or coupled to the other element or layer or intervening elements or layers may be present. In contrast, when an element is referred to as being “directly on,” “directly connected to,” or “directly coupled to” another element or layer, there may be no intervening elements or layers present. Like reference numerals refer to like elements throughout.

As used herein, the term “and/or” may include any and all combinations of one or more of the associated listed items. As further used herein, the singular forms “a,” “an” and “the” are intended to include the plural forms as well, unless the context clearly indicates otherwise.

Spatially relative terms, such as “beneath,” “below,” “lower,” “above,” “upper” and the like, may be used herein to describe a relationship of one element or feature to another element(s) or feature(s) as illustrated in the figures. Accordingly, it will be understood that the spatially relative terms are intended to encompass different orientations of the device in use or operation in addition to the orientation depicted in the figures. For example, if the device in the figures is turned over, elements described as “below” other elements or features would then be oriented “above” the other elements or features.

Additionally, the example embodiments of the present invention should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Thus, the regions illustrated in the figures are schematic in nature and their shapes are not intended to illustrate the actual shape of a region of a device and are not intended to limit the scope of the present invention.

Unless otherwise defined, all terminology used herein is given its ordinary meaning in the art, and therefore, should be interpreted within the context of the specification and the relevant art as understood by one of ordinary skilled in the art.

An example embodiment of a slurry composition according to the present invention may include an abrasive, a solvent having a basic compound, and a non-ionic surfactant.

The abrasive of the slurry composition according to an embodiment of the present invention may chemically and mechanically polish a polysilicon layer by a chemical mechanical polishing (CMP) process. The abrasive may include colloidal silica, cerium oxide, fumed silica, or a mixture thereof in an amount of about 1% to about 20% by weight of the total slurry composition. For example, the abrasive may be present in the slurry composition in an amount of about 1% to about 5% percent by weight of the total slurry composition.

When the amount of the abrasive in the slurry composition is below about 1% by weight of the total slurry composition, the efficiency of the polishing of a polysilicon layer may be decreased, thereby reducing the polishing uniformity thereof. In other words, an insufficient amount of abrasive in the slurry composition, i.e., below about 1%, may trigger removal of irregular portions of the polysilicon layer during polishing, such that the generated polysilicon layer may have a non-uniform surface. On the other hand, when the amount of the abrasive in the slurry composition exceeds about 20% by weight of the total slurry composition, the polishing rate of the polysilicon layer may not be properly controlled, thereby causing potential damage by removing or scratching portions of the substrate, the silicon oxide layer functioning as a polishing stop, or other underlying layers.

Additionally, when the abrasive of the slurry composition includes colloidal silica, a particle size of the colloidal silica may be in the range of from about 30 nm to about 300 nm. If the particle size of the colloidal silica is below about 30 nm, polished amounts of the polysilicon layer may be non-uniform. On the other hand, if the particle size of the colloidal silica exceeds about 300 nm, scratches may be generated on the silicon oxide layer, the substrate and/or the underlying layers. It should be noted that the colloidal silica employed in an embodiment of the present invention may have an agglomerated structure or a spherical structure, i.e., particles separated from one another.

The solvent of the slurry composition according to an embodiment of the present invention may be present in the slurry composition in an amount of about 89.0% to about 98.995% by weight of the total slurry composition. Preferably, the slurry composition may include about 92.0% to about 97.5% by weight of the solvent containing the basic compound.

If the slurry composition includes below about 89.0% by weight of the solvent, a viscosity of the slurry composition may increase, thereby damaging the CMP apparatus. On the other hand, a solvent amount above about 98.995% by weight of the total slurry composition may reduce the overall viscosity of the slurry composition, thereby decreasing the mechanical polishing rate of the polysilicon layer.

The solvent of the slurry composition may include a basic compound, so that a pH of the slurry composition may be sufficiently basic to improve the polishing rate of the polysilicon layer. In particular, the basic compound of the solvent may adjust the pH of the slurry composition from a neutral state to a basic state, e.g., the slurry composition may have a pH of about 9 to about 12. More specifically, the basic compound of the solvent may include an alkali material, e.g., tetramethyl ammonium hydroxide, tetraethyl ammonium hydroxide, potassium hydroxide (KOH), ammonium hydroxide (NH₄OH), tetrabutyl ammonium hydroxide, cyclohexyl amine, tetramethyl ammonium chloride, tetraethyl ammonium chloride, like alkalis, or a mixture thereof.

The solvent of the slurry composition according to an embodiment of the present invention may include water.

The non-ionic surfactant of the slurry composition according to an embodiment of the present invention may have a high solubility as compared to water and include both a hydrophobic portion and a hydrophilic portion and, thereby, minimize dishing of the polysilicon layer. The non-ionic surfactant may be present in the slurry composition in an amount of about 0.005% to about 1.0% by weight of the total slurry composition. For example, the non-ionic surfactant may be present in the slurry composition in an amount of about 0.1% to about 0.9% by weight of the total slurry composition. In an example embodiment, a non-ionic surfactant amount of about 0.005% by weight of the total slurry composition may correspond to an amount of about 50 ppm of the non-ionic surfactant. Similarly, a non-ionic surfactant amount of about 1.0% by weight of the total slurry composition may correspond to an amount of about 10,000 ppm of the non-ionic surfactant.

If the amount of the non-ionic surfactant is below about 0.005% by weight of the total slurry composition, the polysilicon layer may not be sufficiently protected from dishing during the CMP process. On the other hand, an amount of the non-ionic surfactant above about 1.0% by weight of the total slurry composition may trigger a decrease in the viscosity of the slurry composition, thereby decreasing the polishing rate of the polysilicon layer.

The non-ionic surfactant may include polyoxyethylene isooctylcyclohexyl ether, polyoxyethylene sorbitan fatty acid ester, like surfactants, or a mixture thereof. In particular, polyoxyethylene isooctylcyclohexyl ether in the non-ionic surfactant of an example embodiment of the present invention may be represented by the chemical formula (1), wherein R may be an alkyl group and X may be an integer in a range of 9 to 40.

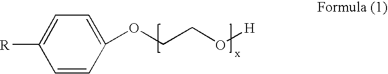

Similarly, polyoxyethylene sorbitan fatty acid ester in the non-ionic surfactant of an embodiment of the present invention may be represented by the chemical formula (2), wherein R may be an alkyl group, and x, y, z and w may be positive integers. Additionally, x, y, z and w may be related by 20≦x+y+z+w≦100.

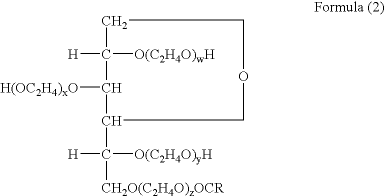

Without intending to be bound by theory, it is believed that the hydrophobic portion of the non-ionic surfactant may be able to selectively attach to a hydrophobic surface of the polysilicon layer and be adsorbed therein. Adsorption of the non-ionic surfactant into the polysilicon layer may prevent a chemical reaction between the basic compound in the slurry composition and the polysilicon layer, thereby minimizing dishing of the polysilicon layer. Therefore, when polysilicon patterns having different widths are polished with the slurry composition according to the present invention, the non-ionic surfactant in the slurry composition may effectively minimize dishing of the polysilicon patterns, thereby providing uniform polishing thickness thereto. In particular, such polishing thickness uniformity may be advantageous when the polysilicon layer serves as a floating gate of a non-volatile semiconductor device, e.g., a flash memory device.

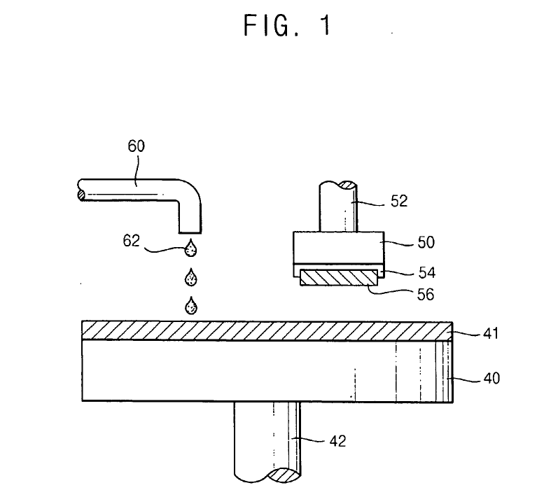

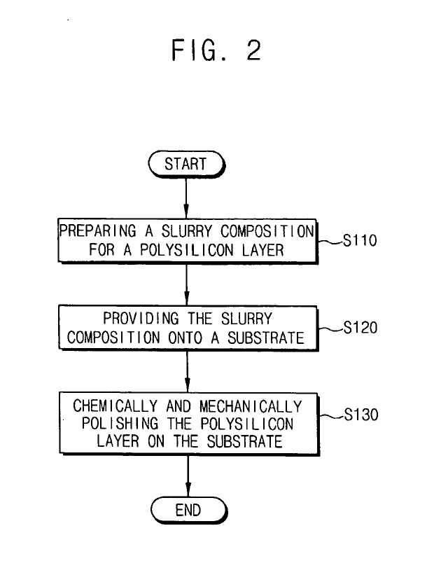

In another aspect of the present invention, an example embodiment of a method of polishing polysilicon layers with the inventive slurry composition will be described in detail below. In particular, a method of polishing polysilicon layers in accordance with an example embodiment of the present invention will be described with respect to a chemical-mechanical polishing apparatus illustrated in FIG. 1 and a polishing method illustrated in FIG. 2.

As illustrated in FIG. 1, a chemical-mechanical polishing apparatus may include a polishing table 40 with a polishing pad 41, a polishing head 50 above the polishing pad 41, and a slurry supply member 60 providing a slurry composition 62 to the polishing table 40.

The polishing table 40 may be coupled to a first rotating axis 42, such that the first rotating axis 42 may rotate the polishing table 40 using a first motor (not shown).

The polishing head 50 may be positioned above the polishing pad 41 and hold a substrate 56 via a lower clamp 54, such that the substrate 56 may be positioned between the polishing head 50 and the polishing pad 41, as illustrated in FIG. 1. During a polishing process, the substrate 56 and the polishing pad 41 may be in contact with one another.

The polishing head 50 may be coupled to a second rotating axis 52, such that the second rotating axis 52 may rotate the polishing head 50 via a second motor (not shown). In this respect, it should be noted that descriptive terms such as “first,” “second,” and so forth may refer to elements employed in an embodiment of the present invention for the purpose of distinguishing one element from another only. The polishing head 50 and the polishing table 40 may be rotated either in a same direction or in opposite directions.

The substrate 56 may be formed of silicon and include a cell area and a peripheral circuit area. The substrate 56 may include a silicon oxide structure and a polysilicon layer. In particular, the substrate 56 may include a polysilicon layer to be polished and a silicon oxide structure functioning as a polishing stop, i.e., isolation layer. More specifically, a first isolation layer, i.e., a first silicon oxide structure, having a first width may be formed on the cell area of the substrate 56, and a second isolation layer, i.e., a second silicon oxide structure, having a second width substantially wider than the first width may be formed on the peripheral circuit area of the substrate 56. Accordingly, the polysilicon layer may be positioned on the first and second isolation layers, i.e., the polysilicon layer may be positioned on the silicon oxide structure.

It should be noted that the second isolation layer may have a concave surface.

The method of polishing the polysilicon layer of the substrate may be described in more detail with respect to FIG. 2. In particular, as illustrated in FIG. 2, the slurry composition 62 may be prepared in step S110. The slurry composition 62 may include about 1 to about 20 percent by weight of abrasive, about 0.005 to about 1 percent by weight of a non-ionic surfactant, and a solvent having a basic compound. However, since the slurry composition 62 may be identical to the slurry composition described previously, its detailed description will not be repeated herein.

Next, the substrate 56 may be affixed to the polishing head 50. The substrate 56 may be attached to the polishing head 50, such that during polishing, the polysilicon layer may be in contact with the polishing pad 41. After the substrate 56 is affixed to the polishing head 50, the slurry composition 62 may be provided onto the substrate 56, as illustrated in step S120 of FIG. 2. In particular, the slurry composition 62 may be provided between the polysilicon layer and the polishing pad 41.

Next, in step S130, the polysilicon layer of the substrate 56 may be chemically and mechanically polished by the slurry composition 62 and the rotation of the polishing table 50 and polishing pad 41, until a surface of the silicon oxide structure may be exposed. The substrate 56, i.e., the polysilicon layer of the substrate 56, and the polishing pad 41 may be in contact with one another while rotating in the same direction or opposite directions. Additionally, the polysilicon layer of the substrate 56, the polishing pad 41, and the slurry composition 62 may be in contact with one another, thereby forming a pattern in the polysilicon layer without dishing thereof. In other words, the polysilicon layer may have a uniformly patterned surface.

Alternatively, the CMP process, i.e., polishing, may be performed on the substrate 56 until the polysilicon layer in contact with the second isolation layer, i.e., silicon oxide structure having a concave surface, may be removed completely.

In yet another alternative, the surface of the polysilicon layer may be first partially pre-polished with a slurry composition having only abrasive and solvent, i.e., no non-ionic surfactant. Subsequently, the polysilicon layer may be polished in the CMP process by the slurry composition 62.

Formation of polysilicon patterns with different widths by employing the slurry composition 62 as described above may be advantageous due to minimized dishing of the polysilicon patterns stemming from effective protection thereof by the non-ionic surfactant. As a result, a thickness distribution of the polysilicon patterns may be uniform due to the minimized dishing.

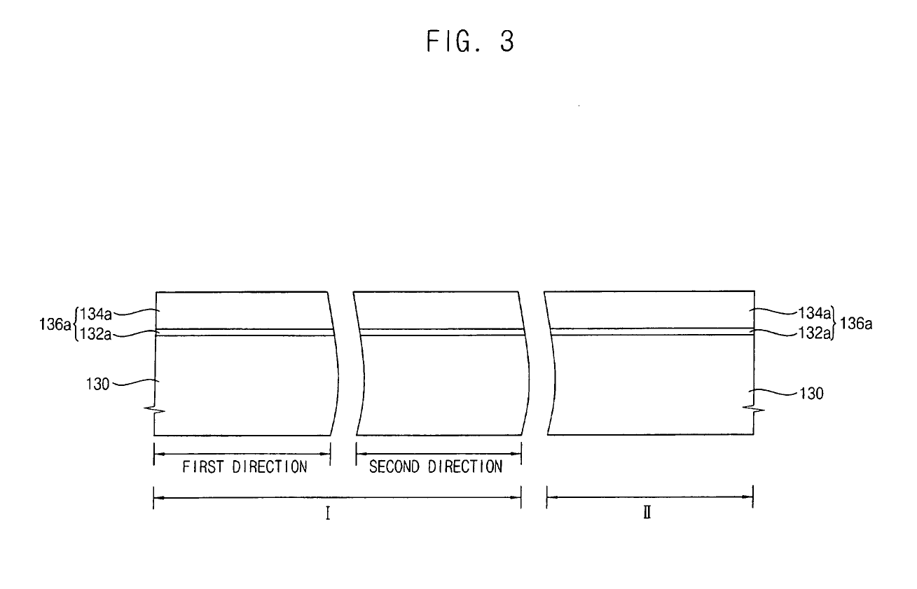

In another aspect of the present invention, an example embodiment of a method of manufacturing a semiconductor device by polishing polysilicon layers with the inventive slurry composition will be described in detail below with respect to FIGS. 3-10. In particular, FIGS. 3-10 illustrate an example manufacturing process of a non-volatile semiconductor device, e.g., a flash memory device. However, other semiconductor devices, such as volatile memory devices, e.g., DRAM, SRAM, and so froth, are not excluded from the scope of the present invention. It should also be noted that in FIGS. 3-10 a cell area of the substrate is represented by two cross-sectional views, i.e., a first direction and a second direction that may be perpendicular to one another. A peripheral circuit area II of the substrate is represented only by one cross-sectional view, i.e., a same direction as the second direction. Accordingly, for purposes of description of an embodiment of the present invention the first and second directions will be referred hereinafter as X-axis and Z-axis, respectively.

As illustrated in FIG. 3, a semiconductor substrate 130 having a cell area I and a peripheral circuit area II may be provided. The semiconductor substrate 130 may include a silicon substrate or a silicon-on-insulator (SOI) substrate.

Next, a mask layer 136a may be formed on the semiconductor substrate 130. The mask layer 136a may include a single layered structure having a silicon nitride film. Alternatively, as further illustrated in FIG. 3, the mask layer 136a may include a double layered structure having a silicon oxide film 132a and a silicon nitride film 134a.

The silicon oxide film 132a of the mask layer 136a may be deposited on the semiconductor substrate 130 by any convenient process as determined by one of ordinary skilled in the art, e.g., a thermal oxidation process, a chemical vapor deposition (CVD) process, and so forth, to a thickness of from about 70 angstroms to about 100 angstroms. The silicon oxide film 132a may function as a pad oxide film.

The silicon nitride film 134a of the mask structure 136a may be formed by depositing a dichlorosilane (SiH₂Cl₂) gas, a silane (SiH₄) gas, an ammonia (NH₃) gas or a like gas on the silicon oxide film 132a by any convenient process as determined by one of ordinary skill in the art, e.g., a low pressure chemical vapor deposition (LPCVD) process, a plasma-enhanced chemical vapor deposition (PECVD), and so forth. The silicon nitride film 134a may function as a hard mask film.

Once the mask layer 136a is formed on the semiconductor substrate 130, a photoresist pattern (not shown) may be formed on the mask layer 136a. The photoresist pattern may be used as an etching mask and selectively expose portions of the mask layer 136a to facilitate partial etching thereof. For example, the photoresist pattern may partially expose portions of the mask layer 136a along the second direction.

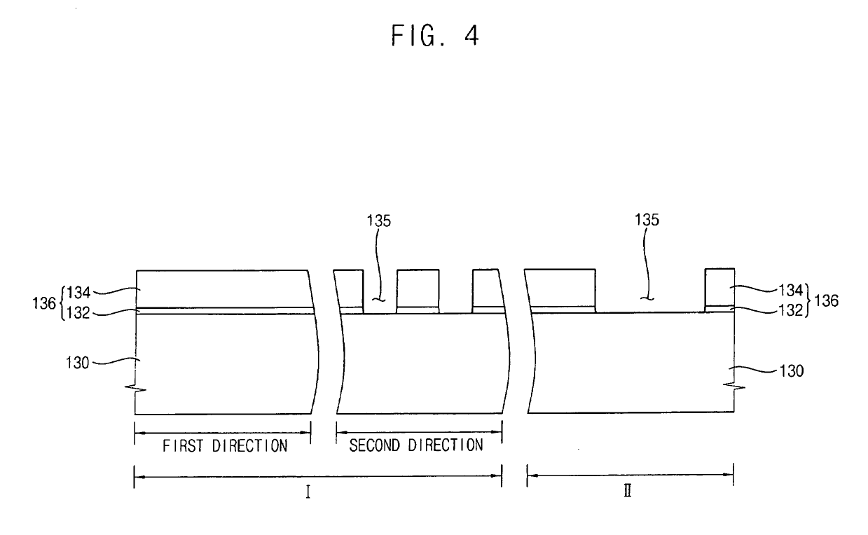

As illustrated in FIG. 4, the mask layer 136a may be etched to correspond to the photoresist pattern, e.g., the mask layer 136a may be etched to partially expose portions of the semiconductor substrate 130 along the second direction. After etching, the photoresist pattern may be removed from the mask layer 136a by a stripping process using plasma, e.g., oxygen plasma, to form a mask pattern 136. The mask pattern 136 may have a plurality of first openings 135 along the second directions, such that portions of the semiconductor substrate 130 corresponding to the plurality of first opening 135 may be exposed. In this respect, it should be noted that when the mask layer 136a includes a multi layer structure, all the layers of the mask layer 136a may be etched. For example, upon etching of the mask layer 136a, the silicon oxide film 132a and the silicon nitride film 134a may be etched to form an oxide film pattern 132 and a silicon nitride film pattern 134, respectively.

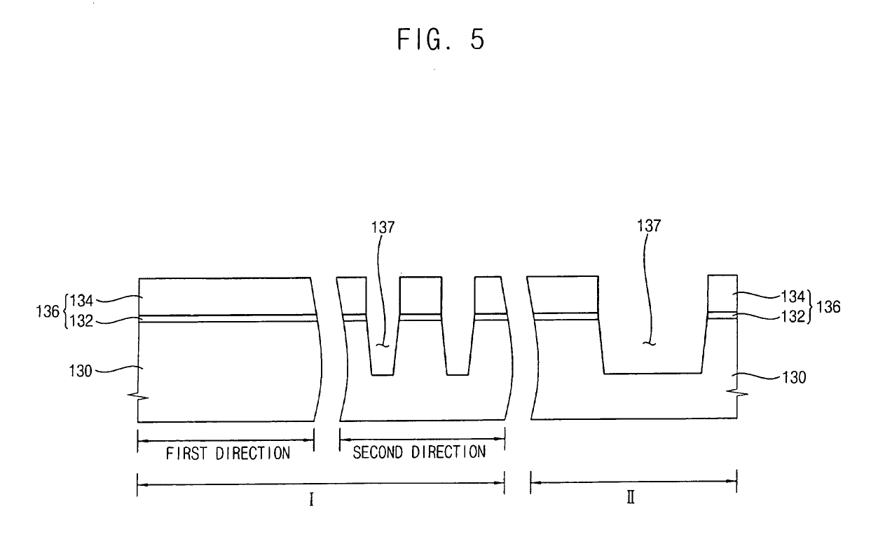

Next, as illustrated in FIG. 5, portions of the semiconductor substrate 130 exposed by the plurality of the first openings 135 may be etched using the mask pattern 136 as an etching mask to form a plurality of trenches 137 at an upper portion of the semiconductor substrate 130. In other words, each of the plurality of the first openings 135 may be expanded vertically in a downward direction to remove corresponding portions of the semiconductor substrate 130.

According to an example embodiment of the present invention, after formation of the plurality of trenches 137, a sidewall oxide layer (not shown) may be formed on a sidewall of each of the plurality of trenches 137 to repair any potential damage to the semiconductor substrate 130 caused during formation of the trench 137. The sidewall oxide layer may be formed on the sidewall of each of the plurality of trenches 137 by, for example, a thermal oxidation process.

According to an example embodiment of the present invention, a liner layer (not shown) may be formed on the sidewall and a bottom of each of the plurality of trenches 137 to minimize impurities diffusion into the semiconductor substrate 130. If the sidewall oxide layer is employed, the liner layer may be applied thereto. The liner layer may be formed of a nitride, e.g., silicon nitride, by a CVD process.

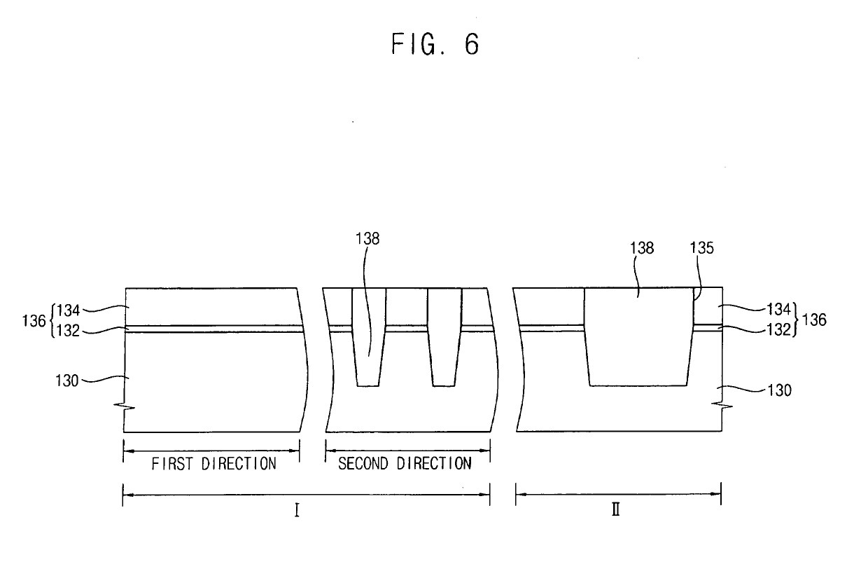

Once the plurality of trenches 137 is complete, an isolation layer 138 may be formed on the mask pattern 136, such that the plurality of trenches 137 may be filled, as illustrated in FIG. 6. The isolation layer 138 may be a silicon oxide layer. The isolation layer 138 on the mask pattern 136 may be partially removed by a first CMP process to expose the mask pattern 136, i.e., the isolation layer may fill the trenches 137 without covering an upper surface of the mask pattern 136.

As further illustrated in FIG. 6, a first portion of the isolation layer 138 in the cell area I may have a first width, and a second portion of the isolation layer 138 in the peripheral circuit area II may have a second width substantially wider than the first width. The second portion of the isolation layer 138 may have a concave surface caused by dishing generated in the first CMP process.

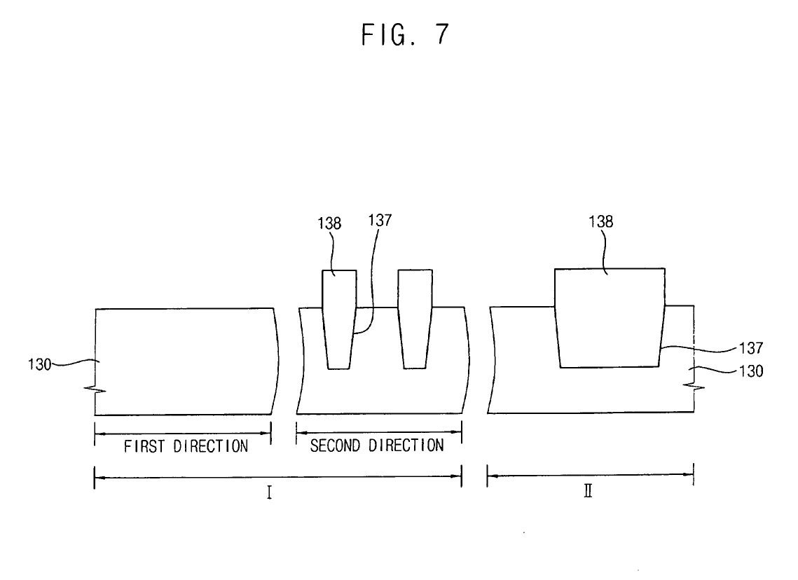

Next, as illustrated in FIG. 7, the mask pattern 136 may be removed to expose an upper surface of the semiconductor substrate 130 adjacent to the isolation layer 138. In other words, after removal of the mask pattern 136, portions of the isolation layer 139 may protrude in an upward direction above the semiconductor substrate 130, such that at least one second opening may be formed between two protruding adjacent portions of the isolation layers 138 to expose a portion of the semiconductor substrate 130.

The mask pattern 136 may be removed by a wet etching process using an etching solution, while the etching solution may include a phosphoric acid solution and have an etching selectivity correlated to a nitride and/or an oxide layer. During removal of the mask pattern 136, the isolation layer 138 may be partially etched, i.e., the isolation layer 138 may have a reduced height as compared to its height before the removal of the mask pattern 136.

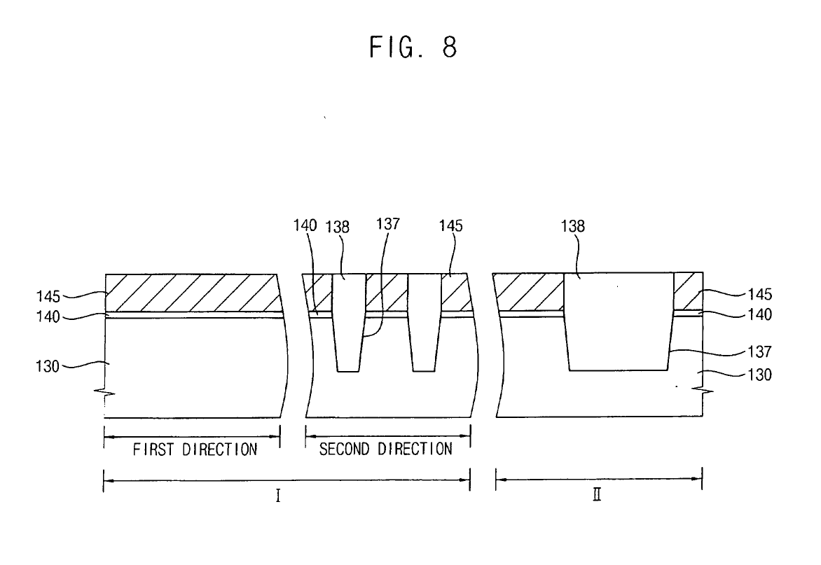

Subsequently, as illustrated in FIG. 8, a tunnel oxide layer 140 may be formed on the upper surface of the semiconductor substrate 130, i.e., a portion of the semiconductor substrate 130 exposed by the isolation layer 138, by applying an oxide, e.g., silicon oxide, via thermal oxidation, radical oxidation, CVD, and so forth.

Once the tunnel oxide layer 140 is formed, a first polysilicon layer (not shown) may be deposited thereon to a predetermined thickness. For example, the first polysilicon layer formed on the cell area I of the semiconductor substrate 130 may be formed to sufficiently fill up the second opening between the isolation layers 138. It should be noted, however, that the predetermined thickness of the first polysilicon layer may be substantially lower as compared to a thickness of the mask pattern 136 due to the reduced height of the isolation layer 138 after partial etching thereof.

The first polysilicon layer may be partially etched to form a floating gate 145 by a second CMP process using the slurry composition described above. In other words, the first polysilicon layer may be treated by the second CMP process until the isolation layer 138 is exposed to facilitate formation of the floating gate 145 on the tunnel oxide layer 140. For example, the second CMP process may be continued in the peripheral circuit area II until the first polysilicon layer positioned on the isolation layer 138 is completely removed. Accordingly, a first portion of the floating gate 145 may be formed on the tunnel oxide layer 140 in the cell area I of the semiconductor substrate 130, such that the floating gate 145 may be positioned between the isolation layers 138. A second portion of the floating gate 145 may be formed on the tunnel oxide layer 140 in the peripheral circuit area II, while the second portion of the floating gate 145 may have a width that is substantially larger than that of the first portion of the floating gate 145.

It should be noted that a height of the floating gate 145 may be lower than a height of the mask pattern 136 due to partial etching of the isolation layer 138. With respect to layers in the present invention, a “height” and a “thickness may be used interchangeably and refer to a distance as measure in a vertical direction, i.e., Y-axis. On the other hand, “width” refers to distances measured along a horizontal direction, e.g., X-axis and Z-axis.

The slurry composition employed in the second CMP process may include about 1 to about 20 percent by weight of an abrasive, about 0.005 to about 1 percent by weight of a non-ionic surfactant, and a solvent having a basic compound. However, since this slurry composition may be identical to the slurry composition described previously, its detailed description will not be repeated herein.

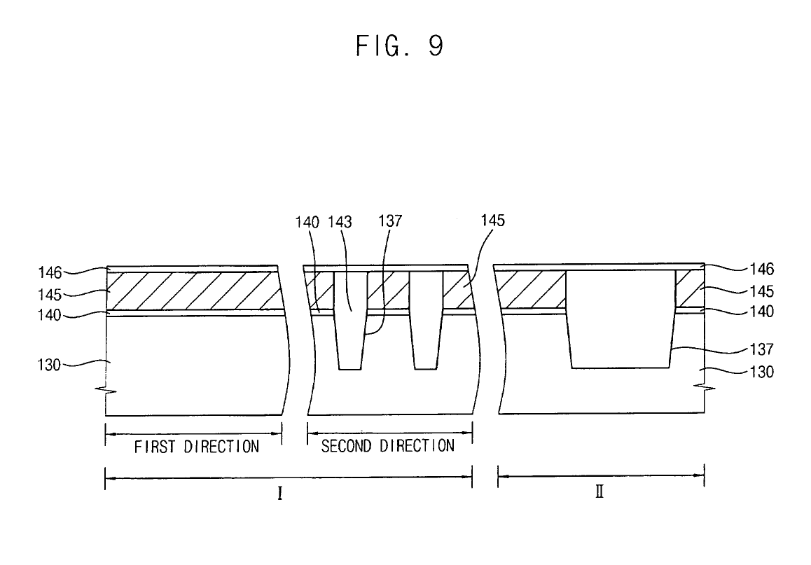

Next, as illustrated in FIG. 9, a dielectric layer 146 may be uniformly deposited on the floating gate 145 and the isolation layer 138. The dielectric layer 146 may have a multi-layered structure that includes alternating layers of oxides and nitrides, e.g., oxide layer/nitride layer/oxide layer (ONO). The dielectric layer 146 may have a thickness of about 150 angstroms to about 200 angstroms as measured vertically from an upper surface of the floating gate 145.

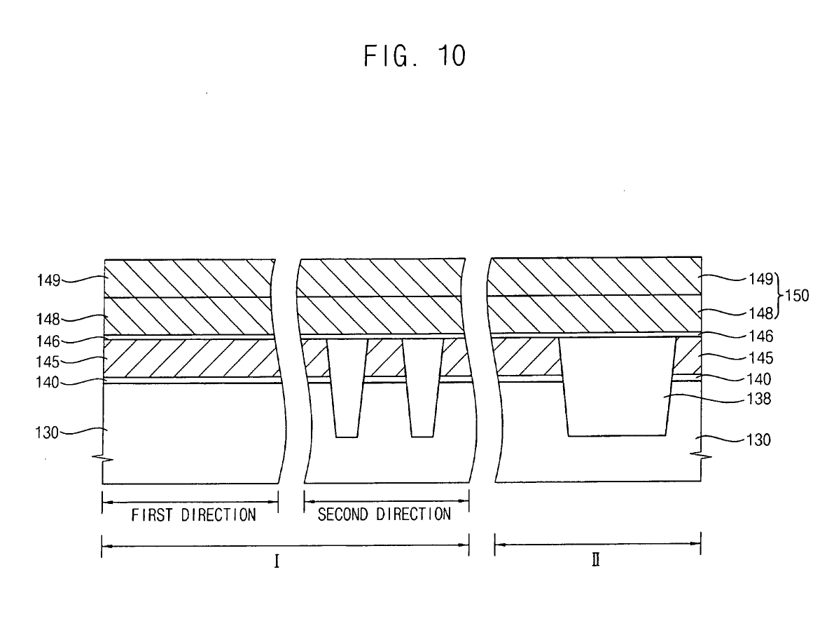

After application of the dielectric layer 146, a second polysilicon layer 148 may be formed thereon, as illustrated in FIG. 10. Next, a metal silicide layer 149 may be formed of tungsten silicide, cobalt silicide or titanium silicide on the second polysilicon layer 148 to facilitate formation of a control gate 150 on the dielectric layer 146. It should be noted, however, that an embodiment of a semiconductor device without the metal silicide layer 149 is not excluded from the scope of the present invention.

The control gate 150, the dielectric layer 146 and the floating gate 145 may be patterned with respect to their respective position in the cell area I and the peripheral circuit area II of the semiconductor substrate 130.

### EXAMPLES

Eight examples of slurry compositions according to example embodiments of the present invention and a comparative example were prepared as follows. Colloidal silica was used as an abrasive in an amount of 3% by weight of the total slurry composition. The amount of the non-ionic surfactant was modified in every example, and the remaining of the slurry composition included water with a basic compound. The samples of the slurry compositions were prepared according to Table 1 below. The comparative example included no non-ionic surfactants.

TABLE 1

| | Amount of Non-ionic Surfactant |
|---|---|
| Slurry Composition | [ppm] |
| Comparative Example | 0 |
| Example 1 | 10 |
| Example 2 | 15 |
| Example 3 | 20 |
| Example 4 | 25 |
| Example 5 | 30 |
| Example 6 | 50 |
| Example 7 | 100 |
| Example 8 | 150 |

Nine (9) blanket substrates were prepared, while each substrate was coated with a polysilicon layer doped with impurities and having a thickness of about 10,000 angstroms. Next, each polysilicon layer was subjected to a chemical mechanical polishing (CMP) process with a different slurry composition.

Each CMP process was performed with a MIRRA-OnTrack (Applied Materials, Inc.) as a chemical mechanical polishing apparatus employing IC1000 stack pad (Rodel Co.) as a polishing pad. Each slurry composition was supplied at a flow rate of about 200 ml/min. Rotation speeds of the polishing table and the polishing head in each CMP apparatus were about 90 rpm and about 85 rpm, respectively.

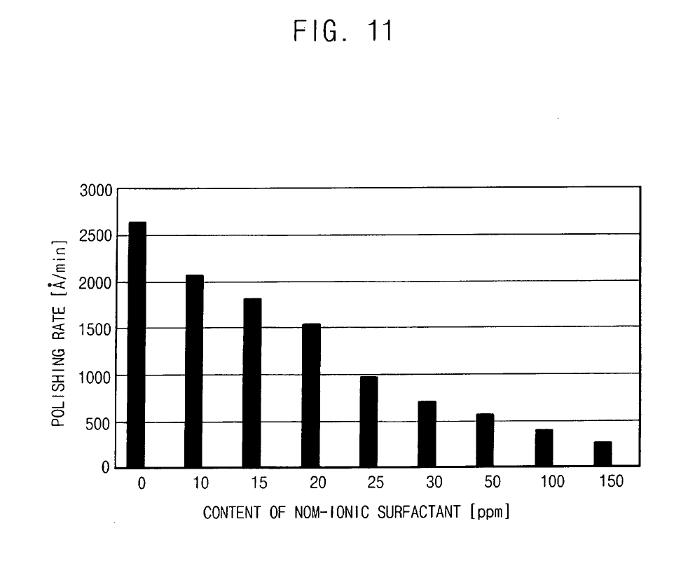

During performance of the CMP processes in each of the above described examples, a polishing rate of each of the polysilicon layers was measured. The results of the measurements are shown in Table 2 below and in a graph illustrated in FIG. 11.

TABLE 2

| | Polishing Rate of Polysilicon Layer |
|---|---|
| Slurry Composition | [Å/min] |
| Comparative Example | 2,638 |
| Example 1 | 2,060 |
| Example 2 | 1,814 |
| Example 3 | 1,525 |
| Example 4 | 974 |
| Example 5 | 704 |
| Example 6 | 593 |
| Example 7 | 404 |
| Example 8 | 271 |

As can be seen in Table 2 and FIG. 11, the polishing rate of a slurry composition having no non-ionic surfactants, i.e., comparative example, has a polishing rate of 2,638 angstroms/min. The polishing rate of the slurry compositions of Examples 1-3 were 2,060 angstroms/min, 1,814 angstroms/min and 1,525 angstroms/min, respectively. In other words, a polishing rate of polysilicon layers with a slurry composition having a non-ionic surfactant in an average amount of 15 ppm have a relatively high polishing rate average value of about 1,800 angstroms/min.

On the other hand, the polishing rates of the polysilicon layers of the slurry compositions of Examples 5-8 were 704 angstroms/min, 593 angstroms/min, 404 angstroms/min and 271 angstroms/min, respectively. In other words, a polishing rate of polysilicon layers with a slurry composition having a non-ionic surfactant in an average amount of over 55 ppm has a relatively low value of about 488 angstroms/min.

In other words, an increased amount of a non-ionic surfactant in the slurry composition may decrease the polishing rates of the polysilicon layers, thereby minimizing dishing of the polysilicon layer patterns during the CMP process and improving uniformity thereof. Use of the non-ionic surfactant may minimize dishing of the polysilicon layer patterns even when a slurry composition with a high polishing selectivity between the polysilicon layer and a silicon oxide layer is employed.

Example embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A slurry composition comprising an abrasive in an amount of about 1 to about 20 percent by weight of the slurry composition, a non-ionic surfactant in an amount of about 0.005 to about 1 percent by weight of the slurry composition, and a solvent having a basic compound.

2. The slurry composition as claimed in claim 1, wherein the abrasive includes colloidal silica, cerium oxide, fumed silica or a mixture thereof.

3. The slurry composition as claimed in claim 1, wherein the abrasive includes colloidal silica having a particle size of about 30 nm to about 300 nm.

4. The slurry composition as claimed in claim 1, wherein the non-ionic surfactant includes polyoxyethylene isooctylcyclohexyl ether represented by Formula (1): 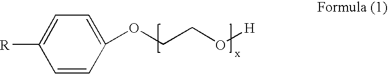
wherein R is an alkyl group and X is an integer in a range of 9 to 40.

5. The slurry composition as claimed in claim 1, wherein the non-ionic surfactant includes polyoxyethylene sorbitan fatty acid ester represented by Formula (2): 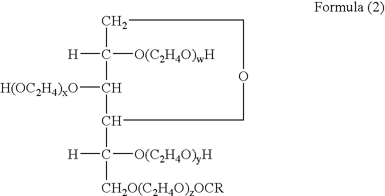
wherein R is an alkyl group, and x, y, z and w are positive integers with the proviso that 20≦x+y+z+w≦100.

6. The slurry composition as claimed in claim 1, wherein the basic compound of the solvent includes tetramethyl ammonium hydroxide, tetraethyl ammonium hydroxide, potassium hydroxide (KOH), ammonium hydroxide (NH₄OH), tetrabutyl ammonium hydroxide, cyclohexyl amine, tetramethyl ammonium chloride, tetraethyl ammonium chloride, or a mixture thereof.

7. The slurry composition as claimed in claim 1, wherein the slurry composition has a pH of about 9 to about 12.

8. A method of polishing a polysilicon layer, comprising:
depositing a polysilicon layer on a silicon oxide layer formed on a substrate;
preparing a slurry composition having about 1 to about 20 percent by weight of abrasive, about 0.005 to about 1 percent by weight of a non-ionic surfactant, and a solvent having a basic compound;
providing the slurry composition onto the polysilicon layer; and
polishing the polysilicon layer to form a polysilicon layer pattern by a chemical mechanical polishing (CMP) process.

9. The method as claimed in claim 8, wherein preparing the slurry composition includes employing colloidal silica having a particle size of about 30 nm to about 300 nm.

10. The method as claimed in claim 8, wherein preparing the slurry composition includes employing polyoxyethylene isooctylcyclohexyl ether as the non-ionic surfactant, the polyoxyethylene isooctylcyclohexyl ether represented by Formula (1): 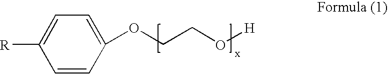
wherein R is an alkyl group and X is an integer in a range of 9 to 40.

11. The method as claimed in claim 8, wherein preparing the slurry composition includes employing polyoxyethylene sorbitan fatty acid ester as the non-ionic surfactant, the polyoxyethylene sorbitan fatty acid ester represented by Formula (2): 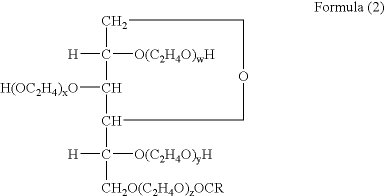
wherein R is an alkyl group, and x, y, z and w are positive integers with the proviso that 20≦x+y+z+w≦100.

12. The method as claimed in claim 8, wherein polishing the polysilicon layer includes removing the polysilicon layer until the silicon oxide layer is exposed.

13. The method of claim 12, wherein polishing the polysilicon layer includes removing the polysilicon layer from a concaved surface of the silicon oxide layer.

14. A method of manufacturing a semiconductor device, comprising:
providing a substrate having a cell area and a peripheral circuit area;
forming a mask layer pattern on the substrate;
etching the substrate through the mask layer pattern to form a plurality of trenches in the substrate;
depositing an isolation layer on the substrate, such that the isolation layer is in contact with inside surfaces of sidewalls of the trenches;
removing the mask layer to expose an upper surface of the substrate, such that the isolation layer is protruding above the upper surface of the substrate;
depositing a tunnel oxide layer on the upper surface of the substrate;
forming a polysilicon layer on the substrate, such that the polysilicon layer is in contact with the tunnel oxide layer and the isolation layer;
polishing the polysilicon layer with a slurry composition to form a floating gate, wherein the slurry composition includes about 1 to about 20 percent by weight of abrasive, about 0.005 to about 1 percent by weight of a non-ionic surfactant, and a solvent with a basic compound;
forming a dielectric layer on the floating gate; and
forming a control gate on the dielectric layer.

15. The method as claimed in claim 14, wherein depositing the isolation layer on the substrate includes forming a first portion of the isolation layer having a first width in the cell area of the substrate, and forming a second portion of the isolation layer having a second width in the peripheral circuit area of the substrate, such that the second width is substantially larger than the first width.

16. The method as claimed in claim 14, wherein depositing the isolation layer on the substrate includes filling up the trenches.

17. The method as claimed in claim 14, wherein depositing the isolation layer on the substrate includes applying a layer of silicon oxide.

18. The method as claimed in claim 14, wherein polishing the polysilicon layer includes forming a floating gate having a lower thickness as compared to a thickness of the mask layer.

19. The method as claimed in claim 14, wherein polishing the polysilicon layer with the slurry composition includes chemical mechanical polishing until the isolation layer is exposed.
